(19) United States
(12) Patent Application Publication
(10) Pub. No.: US 2026/0230973 A1
(43) Pub. Date: Aug. 6, 2026

(54) UPLINK UNPAUSE MODE DURING SEAMLESS ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/457,049

(22) Filed: Jan. 22, 2026

Related U.S. Application Data
(60) Provisional application No. 63/754,823, filed on Feb. 6, 2025.
(60) Provisional application No. 63/838,272, filed on Jul. 3, 2025.
(60) Provisional application No. 63/910,267, filed on Nov. 3, 2025.

(51) Int. Cl. H04W 36/08; H04L 5/00; H04W 36/00; H04W 36/18

(52) U.S. Cl. CPC H04W 36/08; H04L 5/0053; H04W 36/0016; H04W 36/18

(57) ABSTRACT

Uplink (UL) unpause mode during in seamless roaming in wireless local areas (WLANs). A method performed by a current access point (AP) multi-link device (MLD) includes determining whether an UL unpause mode is supported for UL data transmission from a non-AP MLD during a roam procedure for the non-AP MLD to roam from the current AP MLD to a target AP MLD and transmitting, to the non-AP MLD, information indicating whether the UL unpause mode is supported.

### CROSS-REFERENCE TO RELATED APPLICATIONS AND CLAIM OF PRIORITY

This application claims priority under 35 U.S.C. § 119(e) to U.S. Provisional Patent Application No. 63/754,823, filed on Feb. 6, 2025; U.S. Provisional Patent Application No. 63/838,272, filed on Jul. 3, 2025; and U.S. Provisional Patent Application No. 63/910,267, filed on Nov. 3, 2025. The above-identified provisional patent applications are hereby incorporated by reference in their entirety.

### TECHNICAL FIELD

This disclosure relates generally to wireless networks. More specifically, this disclosure relates to uplink (UL) unpause mode during in seamless roaming in wireless local areas (WLANs) including next generation WLANs.

### BACKGROUND

WLAN technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for UL unpause mode during seamless roaming in WLANs.

In one embodiment, a method performed by a current access point (AP) multi-link device (MLD) is provided. The method includes determining whether an UL unpause mode is supported for UL data transmission from a non-AP MLD during a roam procedure for the non-AP MLD to roam from the current AP MLD to a target AP MLD and transmitting, to the non-AP MLD, information indicating whether the UL unpause mode is supported.

In another embodiment, a method performed by a non-AP MLD is provided. The method includes receiving, from a current AP MLD, information indicating whether an UL unpause mode is supported for UL data transmission from the non-AP MLD during a roam procedure for the non-AP MLD to roam from the current AP MLD to a target AP MLD and determining whether to transmit UL data to the current AP MLD during the roam procedure based on whether the UL unpause mode is supported.

In yet another embodiment, an electronic device is provided. The electronic device includes at least one processor including processing circuitry and memory storing instructions. The instructions, when executed by the at least one processor individually or collectively, cause the electronic device to determine whether an UL unpause mode is supported for UL data transmission from a non-AP MLD during a roam procedure for the non-AP MLD to roam from a current AP MLD to a target AP MLD and transmit, to the non-AP MLD, information indicating whether the UL unpause mode is supported.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example procedure for roam execution/transition according to embodiments of the present disclosure;

FIG. 4 illustrates an example procedure for AP side advertisement of uplink unpause mode according to embodiments of the present disclosure;

FIG. 5A illustrates an example procedure for STA processing upon receiving the indication regarding unpause mode support according to embodiments of the present disclosure;

FIG. 5B illustrates example signaling for uplink unpause mode according to embodiments of the present disclosure;

FIG. 5C illustrates an example of a SMD information element including an indication for UL unpause mode according to embodiments of the present disclosure;

FIG. 6 illustrates an example procedure for indication in the common info field according to embodiments of the present disclosure;

FIG. 7 illustrates an example of a common info field including an indication for UL unpause mode according to embodiments of the present disclosure;

FIG. 8 illustrates an example of an UL unpause mode capabilities field according to embodiments of the present disclosure;

FIG. 9 illustrates an example procedure for indication in the MLD capabilities and operations subfield according to embodiments of the present disclosure;

FIG. 10 illustrates an example format for a MLD capabilities and operations subfield according to embodiments of the present disclosure; and

FIG. 11 illustrates an example method performed by an AP MLD in a wireless communication system according to embodiments of the present disclosure.

### DETAILED DESCRIPTION

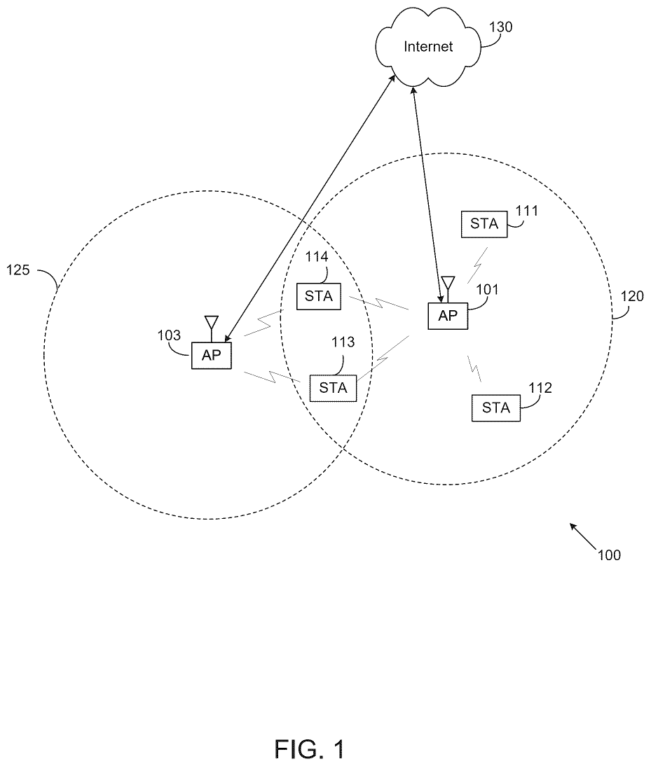

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MHLO). Devices capable of such MLO are referred to as multi-link devices (MLDs).

The following documents and standards descriptions are hereby incorporated into the present disclosure as if fully set forth herein: [1] IEEE P802.11be/D7.0, 2024; and [2] IEEE Std 802.11-2020.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for UL unpause mode during seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

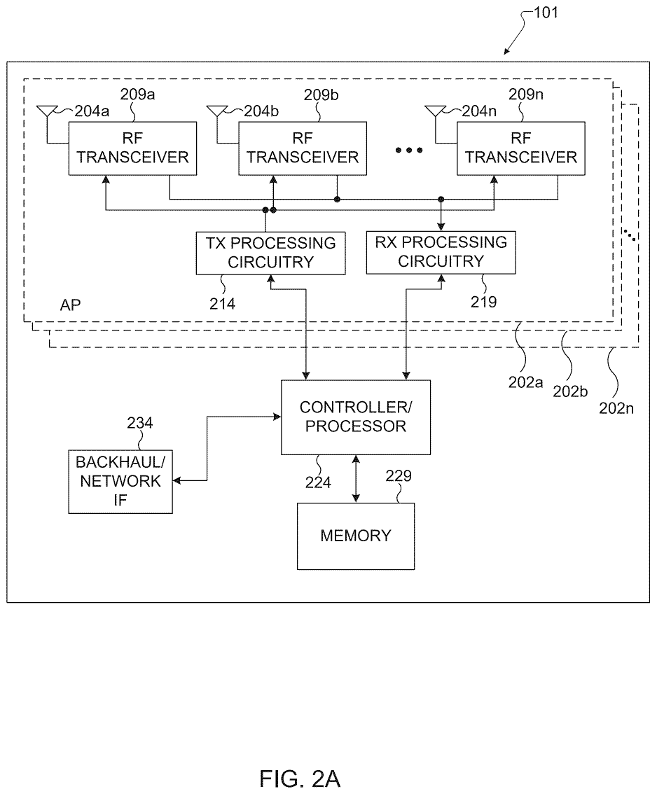

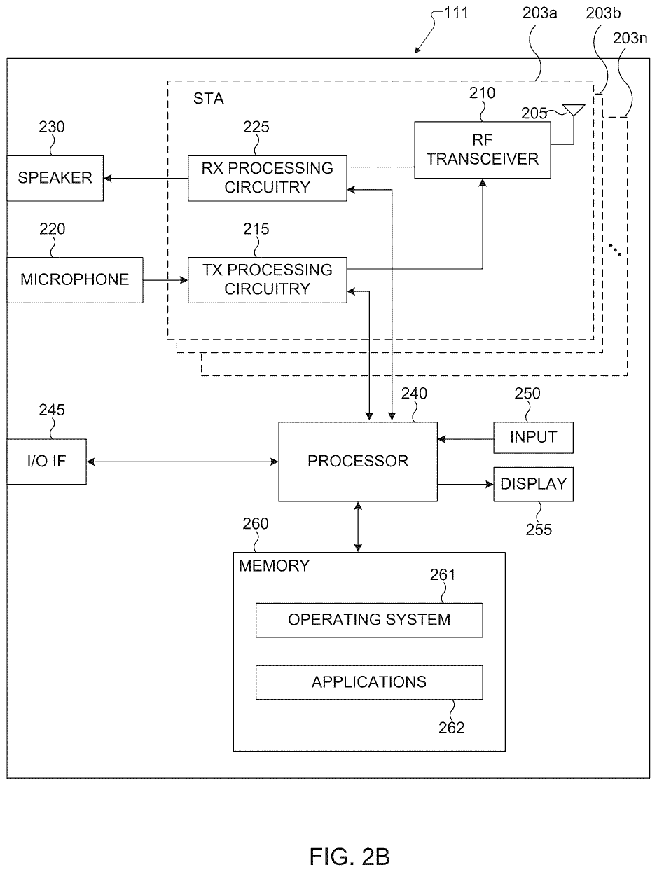

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including UL unpause mode during seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for UL unpause mode during seamless roaming in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate UL unpause mode during seamless roaming in WLANs. In some embodiments, the processor 240 includes at least one microprocessor or microcontroller.

The processor 240 is also capable of executing other processes and programs resident in the memory 260, such as operations for UL unpause mode during seamless roaming in WLANs. The processor 240 can move data into or out of the memory 260 as required by an executing process. In some embodiments, the processor 240 is configured to execute a plurality of applications 262, such as applications for UL unpause mode during seamless roaming in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Seamless roaming in WLANs is a roaming procedure for a non-AP MLD (e.g., STA 111) to transition from a current AP MLD (e.g., AP 101) to a target AP MLD (e.g., AP 103) with a goal such that the time during which the connection is lost is minimal. The seamless roaming procedure can enable a non-AP MLD to remain in state 4 of association while transitioning from current AP MLD to target AP MLD.

The roaming procedure can include multiple stages. Two of the important stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from current AP MLD to target AP MLD. The current AP MLD can process the request frame and send a response frame to the non-AP MLD after the transfer of context is complete. These procedures can enable the non-AP MLD to seamlessly roam from current to target AP MLD.

Embodiments of the present disclosure recognize that the non-AP MLD, which can include one or more non-AP STAs affiliated with it, can be capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can transition between the AP MHLDs. The SMD includes a SMD management entity (SMD-ME) for the SMD. The SMD-ME can allow functionalities such as SMD-level authentication and association, IEEE 802.1X authenticator functions and RSNA key management functions for non-AP MLDs across all AP MLDs within the SMD. The SMD can support two data path models between the non-AP MLD and the distribution system (DS). The first can be a one that has one MAC SAP for the SMD, and the second can be a one that has a separate MAC SAP per AP MLD of the SMD. The SMD can only have one of these data path models used. The SMD and the 802.1X Authenticator component in the corresponding SMD-ME are uniquely identified by an SMD identifier.

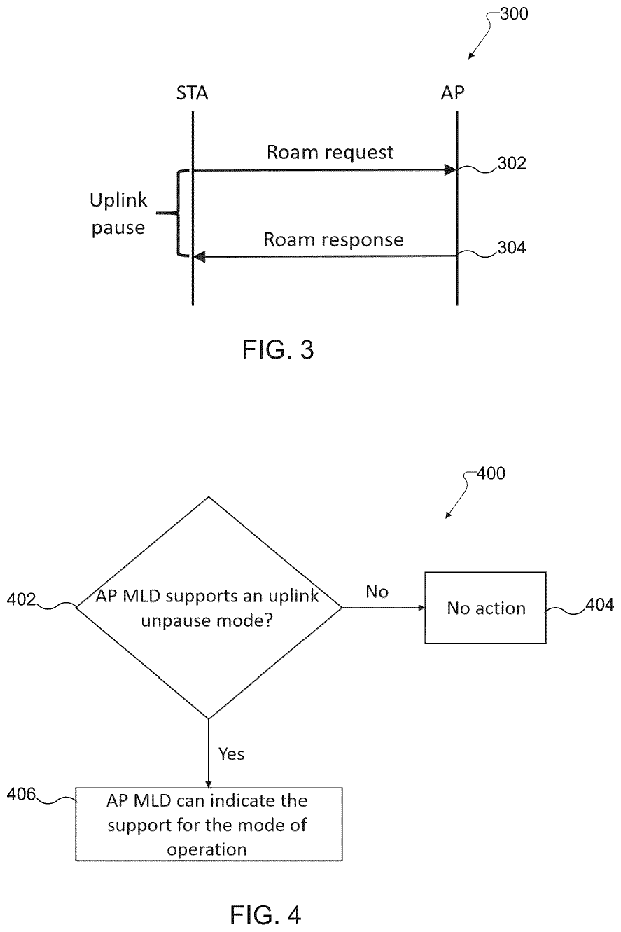

FIG. 3 illustrates an example procedure 300 for roam execution/transition according to embodiments of the present disclosure. For example, the procedure 300 of FIG. 3 can be performed between any of the STAs 111-114 of FIG. 1, such as the AP MLD 111 of FIG. 3 and any of the APs 101-103 of FIG. 1, such as AP MLD 101 of FIG. 2. The procedure 300 is for illustration only and other embodiments can be used without departing from the scope of the present disclosure.

As illustrated in FIG. 3, during the roam execution/transition phase, the non-AP MLD can transmit a roam request to the AP MLD (302) and the AP MLD (i.e., the current or serving AP MLD) transmits a roam response (304). After the roam request is transmitted, there can be a DS remapping to switch the traffic and route it to the target AP MLD. In some networks, when a route switch operation occurs, serving the non-AP MLD's UL traffic at the current AP MLD can lead to complications. For example, there can be some confusion in the route switch operation and traffic can be routed to the current AP MLD again. As a result, in such networks, it can be desired to pause the UL traffic after the roam request is transmitted. However, there can be some networks which may not have such a constraint and can serve the non-AP MLD's traffic during the execution procedure. For example, such networks may involve APs that can communicate with each other to resolve such traffic routing issues. It may be important for the non-AP MLD to understand the configuration on the network side. Otherwise, the non-AP MLD may not be able to take the right action after initiating a roam execution procedure. Embodiments of the present disclosure provide for procedures and signaling to inform non-AP MLD about the support and options available during the roam execution phase.

In this disclosure, a number of solutions are presented for handling an UL unpause mode of operation in next generation WLANs. Various embodiments provide for AP side advertisement/indication of support, non-AP MLD side support, and signaling therefore. Additional embodiments provide for AP side advertisement/indication of support.

According to one embodiment, the AP MLD can advertise the support of a mode of operation in which the UL transmission does not need to be paused. The AP MLD can provide an indication to the non-AP MLD about the support. The indication can be provided by sharing an indication message which can include at least one or more of the following information items provided in the tables below.

TABLE 1
Indication message information content

| Information | |
|---|---|
| item | Description |
| Mode | One or more information items that can indicate that the mode of operation |
| indication | in which UL data can be transmitted by the non-AP MLD during the |
| | execution phase is supported. Example signaling for indicating this support |
| | can be as listed in Table 2. If the non-AP MLD is provided with such an |
| | indication, the non-AP MLD can transmit data frames to the current AP |
| | MLD after it transmits the roam execution request frame. |
| Non-AP MLD | One or more information items that can indicate the actions that non-AP |
| side actions | MLD can take during the execution phase or when route switch occurs. |
| AP MLD side | One or more information items that can indicate how AP MLD handles the |
| actions | UL traffic during the execution phase or when route switch occurs. |
| | Examples of AP side actions can be as shown in Table 3. |
| Non-AP MLD | One or more information items that can indicate any restrictions to be |
| side | followed on the non-AP MLD side. E.g., frames of only a certain set of |
| restrictions | TIDs can be transmitted on the UL, max cap on the amount of data that |
| | can be transmitted on the UL during the execution phase, etc. |

TABLE 2
Mode indication signaling examples

| Example | Description |
|---|---|
| Bit based | A bit that can take a predetermined value (e.g., 1) to make the indication |
| indication | for the support and another predetermined value (e.g., 0) to indicate the |
| | absence of the support. |
| Field based | A field that can take a particular encoding to make the indication for the |
| indication | support. |
| Implicit | An implicit indication can be provided by linking the support to another |
| indication | support. E.g., if a network supports a wireless distribution system, then it |
| | can be understood by the non-AP MLD that a mode of operation in which |
| | UL does not need to be paused can be supported. |

TABLE 3
Example AP MLD side actions

| AP MLD side | |
|---|---|
| actions | Description |
| Forward to DS | The current AP MLD can forward the frames received from the non-AP |
| | MLD during the execution phase to the DS. |
| Forward to target | The current AP MLD can forward the frames received from the non-AP |
| AP MLD | MLD during the execution phase to the target AP MLD and have the |
| | target AP MLD forward to the DS. |
| Drop the frames | The current AP MLD can drop the frames and not pass them to the next |
| | MAC process. |

FIG. 4 illustrates an example procedure 400 for AP side advertisement of UL unpause mode according to embodiments of the present disclosure. For example, the procedure 400 of FIG. 4 can be performed by any of the APs 101-103 of FIG. 1, such as AP MLD 101 of FIG. 2. The procedure 400 is for illustration only and other embodiments can be used without departing from the scope of the present disclosure.

As illustrated in FIG. 4, the AP MLD determines whether UL unpause mode is supported (402). For example, whether UL unpause mode is supported may be a function of network settings in the WLAN, AP capabilities, network or DS capabilities, and/or network conditions. The AP MLD may make this determination on its own or may be informed of support for UL unpause mode by another entity such as another AP MLD (e.g., the target AP MLD) or a management entity or network controller such as the SMD-ME. If not supported, the AP MLD may do nothing (404) (i.e., the STA may assume to pause UL traffic upon initiating the roam procedure. Alternatively, the AP MLD could indicate to the non-AP MLD that UL unpause mode is not supported or to pause UL traffic. If the UL unpause mode is supported, the AP MLD then transmits to the non-AP MLD that UL unpause mode is supported (406).

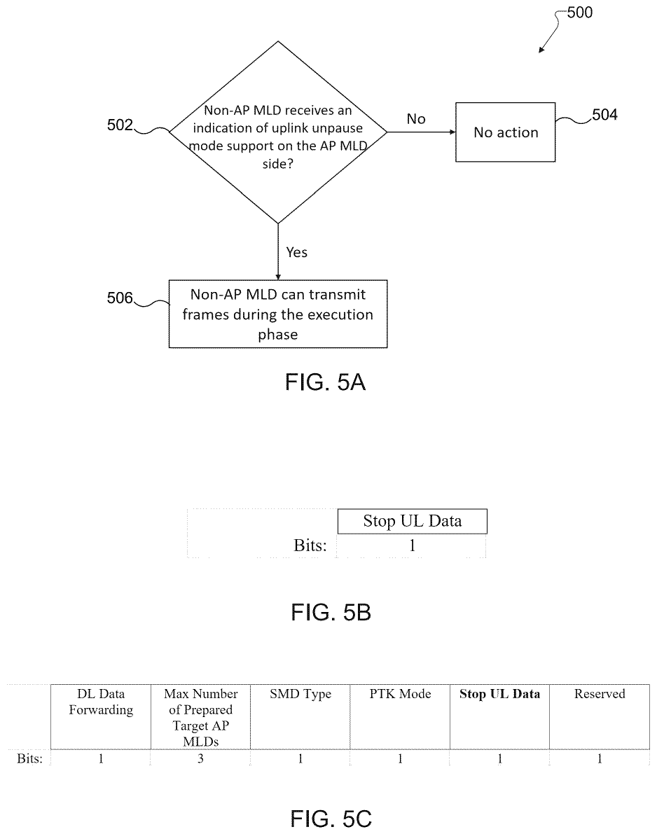

FIG. 5A illustrates an example procedure 500 for STA processing upon receiving the indication regarding unpause mode support according to embodiments of the present disclosure. For example, the procedure 500 of FIG. 5A can be performed by any of the STAs 111-114 of FIG. 1, such as the non-AP MLD 111 of FIG. 3. The procedure 500 is for illustration only and other embodiments can be used without departing from the scope of the present disclosure.

As illustrated in FIG. 5A, the non-AP MLD receives an indication whether UL unpause mode is supported on the AP MLD side (502). If not supported, the non-AP MLD may do nothing (504) (i.e., the STA may assume to pause UL traffic upon initiating the roam procedure. If the UL unpause mode is supported, the non-AP MLD then determines that it may continue to transmit UL data frames to the current AP MLD during the execution phase of the roam (506).

FIG. 5B illustrates example signaling for UL unpause mode according to embodiments of the present disclosure. The embodiment of the example signaling shown in FIG. 5B is for illustration only. Other embodiments could be used without departing from the scope of this disclosure.

In one example, the ST preparation response frame (e.g., a UHR link reconfiguration response frame) can carry the indication. The indication can be as illustrated in FIG. 5B with a bit to indicate to the non-AP MLD whether to stop UL data transmissions.

The stop UL data field can indicate whether the non-AP MLD can be allowed to send data frames to the current AP MLD after the non-AP MLD sends the roam execution request requesting transition to the target AP MLD. This field can be set to 1 if the non-AP MLD is not allowed to send data frames to the current AP MLD after the non-AP MLD sends the roam execution request frame. Otherwise, it can be set to 0.

If a non-AP MLD receives a preparation response frame with the stop UL data bit set to 1, the non-AP MLD can stop transmitting data frames after it successfully transmits the roam execution request frame.

If a non-AP MLD receives a preparation response frame with the stop UL data bit set to 0, the non-AP MLD can continue to transmit data frames after it successfully transmits the roam execution request frame.

The stop UL data bit can be carried in common info field of the STA info field of the ST preparation response frame.

In this procedure, for each roam, each AP MLD can indicate during the preparation whether the UL needs to be paused during the roam/ST execution phase to a target AP MLD. Thus, when an ST execution is performed within a timeout from the ST preparation phase, the non-AP MLD can continue its UL frame transmissions to the current AP MLD.

When the current AP MLD receives UL frames from the non-AP MLD during the preparation phase and the non-AP MLD has been provided an indication that the UL can continue during the ST execution phase, the current AP MLD can forward the frames to the higher layers/DS.

When a non-AP MLD does not receive such an indication, the non-AP MLD can pause its UL data transmission. If the non-AP MLD transmits frames to the current AP MLD during the ST execution phase and the non-AP MLD has been provided an indication to pause its UL transmission, then the current AP MLD can drop the frames and not pass them to the higher layer/DS. In this case, the non-AP MLD can receive block acknowledgement frames confirming the successful reception of the UL frames.

In another example, a background traffic management (BTM) request frame can carry the indication using the example signaling shown in FIG. 5B. The indication can be carried in a neighbor report in the BTM request frame. When a non-AP MLD receives an indication that the UL frames can be transmitted during the ST execution phase, the non-AP MLD can continue to transmit UL frames to the current AP MLD during the ST execution phase. When the non-AP MLD does not receive such an indication, the non-AP MLD can pause its UL transmission during the ST execution phase.

Various embodiments provide for non-AP MLD side support for the UL pause mode indication. According to one embodiment, the non-AP MLD can provide an indication of the support for UL unpause mode described above. The non-AP MLD can make an indication of the support in one or more frames that it can transmit. E.g., there can be a bit based indication in which a bit can take a predetermined value (e.g., 1) to indicate the support and to another predetermined value (e.g., 0) to indicate the absence of the support.

According to one embodiment, the AP MLD can advertise the support in management frames. E.g., beacons, probe responses, etc. that it can transmit. The indication can be carried in an SMD information element. The SMD information element can carry a field (e.g., a bit) that can take a predetermined value (e.g., 1) to indicate that the UL can continue and to another predetermined value (e.g., 0) to indicate otherwise. This indication can apply to all the AP MLDs in the SMD.

FIG. 5C illustrates an example of a SMD information element including an indication for UL unpause mode according to embodiments of the present disclosure. The embodiment of the SMD information element shown in FIG. 5C is for illustration only. Other embodiments could be used without departing from the scope of this disclosure.

The stop UL data field can indicate whether the non-AP MLD can be allowed to send data frames to the AP MLD after the non-AP MLD sends the roam execution request requesting transition to a target AP MLD in the SMD. This field can be set to 1 if the non-AP MLD is not allowed to send data frames to the current AP MLD after the non-AP MLD sends the roam execution request frame. Otherwise, it can be set to 0.

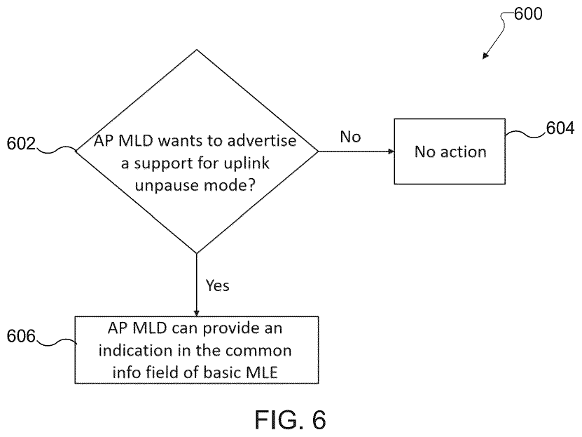

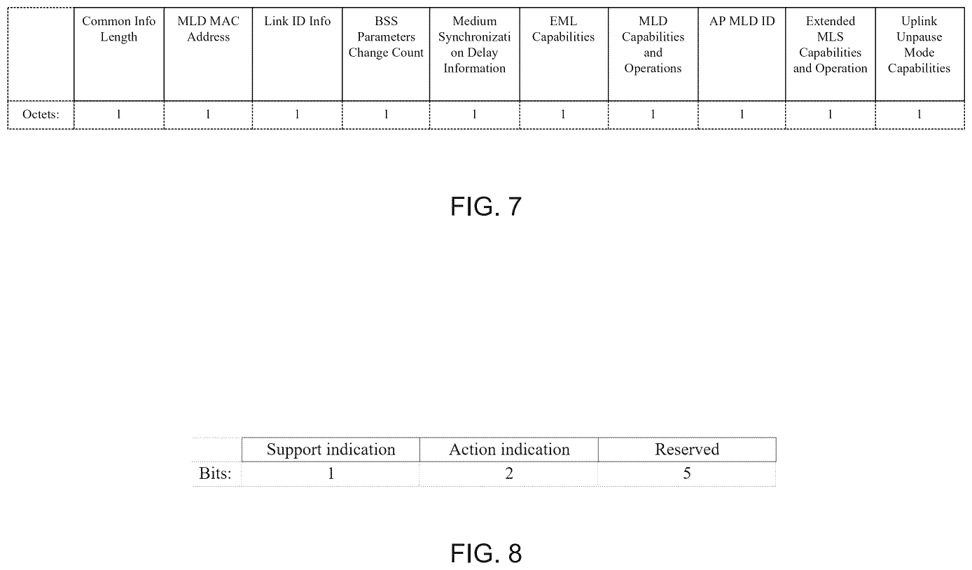

FIG. 6 illustrates an example procedure 600 for indication in the common info field according to embodiments of the present disclosure, and FIG. 7 illustrates an example of a common info field including an indication for UL unpause mode according to embodiments of the present disclosure. For example, the procedure 600 of FIG. 6 can be performed by any of the APs 101-103 of FIG. 1, such as AP MLD 101 of FIG. 2 and a corresponding procedure may be performed by any of the STAs 111-114 of FIG. 1, such as the non-AP MLD 111 of FIG. 3. The procedure 600 is for illustration only and other embodiments can be used without departing from the scope of the present disclosure. The embodiment of the example common info field shown in FIG. 7 is for illustration only. Other embodiments could be used without departing from the scope of this disclosure.

According to one embodiment, there can be an indication in the common info field of the basic multi-link element transmitted by the AP MLD. An example common info field can be as shown in FIG. 7.

As illustrated in FIG. 6, the AP MLD determines whether to advertise support for the UL unpause mode (602). If there is no need to advertise (e.g., the UL unpause mode is not supported or no non-AP MLDs need to know about the support for the UL unpause mode), the AP MLD may do nothing (604). If determining to advertise support for UL unpause mode, the AP MLD then transmits to the non-AP MLD an indication that UL unpause mode is supported in the info field of a basic multi-link element (MLE) (606).

FIG. 8 illustrates an example of an UL unpause mode capabilities field according to embodiments of the present disclosure. The embodiment of the example common info field shown in FIG. 8 is for illustration only. Other embodiments could be used without departing from the scope of this disclosure.

The UL unpause mode capabilities field can have an example format as shown in FIG. 8. For example, the support indication can take a value of 1 to indicate support for the UL unpause mode and to a value of 0 to indicate its absence. The action indication can have an encoding as shown in Table 4.

TABLE 4
Example action indication

| Encoding | Meaning |
|---|---|
| 00 | AP MLD can forward traffic to DS |
| 01 | AP MLD can forward traffic to target AP MLD |
| 10 | AP MLD can drop the traffic received during the |
| | route switch period. |

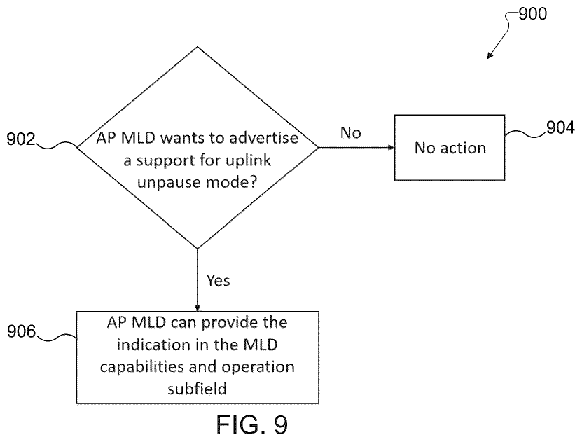

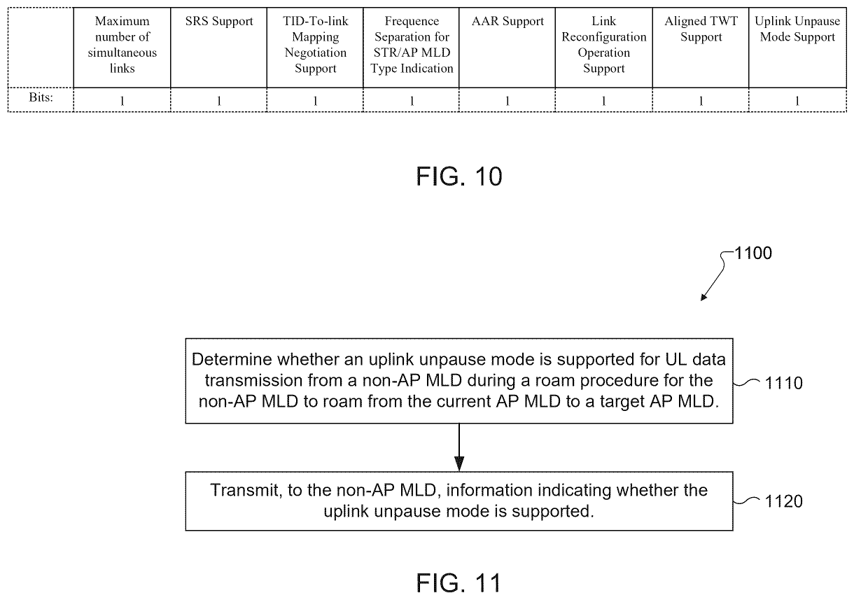

FIG. 9 illustrates an example procedure 900 for indication in the MLD capabilities and operations subfield according to embodiments of the present disclosure, and FIG. 10 illustrates an example format for a MLD capabilities and operations subfield according to embodiments of the present disclosure. For example, the procedure 900 of FIG. 9 can be performed by any of the APs 101-103 of FIG. 1, such as AP MLD 101 of FIG. 2 and a corresponding procedure may be performed by any of the STAs 111-114 of FIG. 1, such as the non-AP MLD 111 of FIG. 3. The procedure 900 is for illustration only and other embodiments can be used without departing from the scope of the present disclosure. The embodiment of the example format for the MLD capabilities and operations subfield shown in FIG. 10 is for illustration only. Other embodiments could be used without departing from the scope of this disclosure.

As illustrated in FIG. 9, the AP MLD determines whether to advertise support for the UL unpause mode (902). If there is no need to advertise (e.g., the UL unpause mode is not supported or no non-AP MLDs need to know about the support for the UL unpause mode), the AP MLD may do nothing (904). If determining to advertise support for UL unpause mode, the AP MLD then transmits to the non-AP MLD an indication that UL unpause mode is supported in the MLD capabilities and operations subfield (906).

In various embodiments, the indication of support for the UL unpause mode can be included in the MLD capabilities and operations subfield of the common info field as illustrated in FIG. 10. For example, the UL unpause mode support can take a value of 1 to indicate a support for the UL unpause mode at the AP MLD side and to a value of 0 to indicate its absence.

When a non-AP MLD receives such an indication, the non-AP MLD can transmit frames to the current AP MLD in the time period between the roam request and roam response frame exchanges. The roam request can also be called as an state transition (ST) execution request frame. The roam response can also be called as an ST execution response frame.

FIG. 11 illustrates an example method 1100 performed by an AP MLD in a wireless communication system according to embodiments of the present disclosure. The method 1100 of FIG. 11 can be performed by any of the APs 101-103 of FIG. 1, such as the AP MLD 101 of FIG. 2A, and a corresponding method can be performed by any of the STAs 111-116 of FIG. 1, such as non-AP MLD 111 of FIG. 2B. The method 1100 is for illustration only and other embodiments can be used without departing from the scope of the present disclosure.

The method 1100 begins with the current AP MLD determining whether an UL unpause mode is supported for UL data transmission from a non-AP MLD during a roam procedure for the non-AP MLD to roam from the current AP MLD to a target AP MLD (1110).

The current AP MLD then transmits, to the non-AP MLD, information indicating whether the UL unpause mode is supported (1120). In various embodiments, the information indicates whether the non-AP MLD is allowed to send UL data frames to the current AP MLD after the non-AP MLD sends a roam execution request for the roam procedure requesting transition to the target AP MLD. In various embodiments, the information indicates whether the UL unpause mode is supported is included in a preparation response frame. In various embodiments, the information indicating whether the UL unpause mode is supported is included in a management frame. In various embodiments, the information indicates whether the UL unpause mode is supported is included in a neighbor report in a BTM request frame. In various embodiments, the information indicating whether the UL unpause mode is supported is included in a SMD information element, and whether the UL unpause mode is supported is common for all AP MLDs in a SMD.

In various embodiments, the current AP MLD receives an UL data frame from the non-AP MLD, wherein the information indicates that the UL unpause mode is not supported. The current AP MLD then transmits a BA frame indicating successful reception of the UL data frame and drops the received UL data frame based on the UL unpause mode not being supported.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a current access point (AP) multi-link device (MLD), the method comprising:
determining whether an uplink (UL) unpause mode is supported for UL data transmission from a non-AP MLD during a roam procedure for the non-AP MLD to roam from the current AP MLD to a target AP MLD; and
transmitting, to the non-AP MLD, information indicating whether the UL unpause mode is supported.

2. The method of claim 1, wherein the information indicates whether the non-AP MLD is allowed to send UL data frames to the current AP MLD after the non-AP MLD sends a roam execution request for the roam procedure requesting transition to the target AP MLD.

3. The method of claim 1, wherein the information indicating whether the UL unpause mode is supported is included in a preparation response frame.

4. The method of claim 1, further comprising:
receiving an UL data frame from the non-AP MLD, wherein the information indicates that the UL unpause mode is not supported;
transmitting a block acknowledgment frame indicating successful reception of the UL data frame; and
dropping the received UL data frame based on the UL unpause mode not being supported.

5. The method of claim 1, wherein the information indicating whether the UL unpause mode is supported is included in a neighbor report in a background traffic management (BTM) request frame.

6. The method of claim 1, wherein the information indicating whether the UL unpause mode is supported is included in a management frame.

7. The method of claim 1, wherein:
the information indicating whether the UL unpause mode is supported is included in a seamless mobility domain (SMD) information element, and
whether the UL unpause mode is supported is common for all AP MLDs in a SMD.

8. A method performed by a non-access point (AP) multi-link device (MLD), the method comprising:
receiving, from a current AP MLD, information indicating whether an uplink (UL) unpause mode is supported for UL data transmission from the non-AP MLD during a roam procedure for the non-AP MLD to roam from the current AP MLD to a target AP MLD; and
determining whether to transmit UL data to the current AP MLD during the roam procedure based on whether the UL unpause mode is supported.

9. The method of claim 8, wherein the information indicates whether the non-AP MLD is allowed to send UL data frames to the current AP MLD after the non-AP MLD sends a roam execution request for the roam procedure requesting transition to the target AP MLD.

10. The method of claim 8, wherein the information indicating whether the UL unpause mode is supported is included in a preparation response frame.

11. The method of claim 8, further comprising:
transmitting an UL data frame from the non-AP MLD, wherein the information indicates that the UL unpause mode is not supported;
receiving a block acknowledgment frame indicating successful reception of the UL data frame; and
determining to retransmit the UL data frame to the target AP MLD after completion of the roam procedure despite receipt of the block acknowledgment frame.

12. The method of claim 8, wherein the information indicating whether the UL unpause mode is supported is included in a neighbor report in a background traffic management (BTM) request frame.

13. The method of claim 8, wherein the information indicating whether the UL unpause mode is supported is included in a management frame.

14. The method of claim 8, wherein:
the information indicating whether the UL unpause mode is supported is included in a seamless mobility domain (SMD) information element, and
whether the UL unpause mode is supported is common for all AP MLDs in a SMD.

15. An electronic device comprising:
at least one processor including processing circuitry; and
memory storing instructions, wherein the instructions, when executed by the at least one processor individually or collectively, cause the electronic device to:
determine whether an uplink (UL) unpause mode is supported for data transmission from a non-access point (AP) multi-link device (MLD) during a roam procedure for the non-AP MLD to roam from a current AP MLD to a target AP MLD; and
transmit, to the non-AP MLD, information indicating whether the UL unpause mode is supported.

16. The electronic device of claim 15, wherein the information indicates whether the non-AP MLD is allowed to send UL data frames to the current AP MLD after the non-AP MLD sends a roam execution request for the roam procedure requesting transition to the target AP MLD.

17. The electronic device of claim 15, wherein the information indicating whether the UL unpause mode is supported is included in a preparation response frame.

18. The electronic device of claim 15, wherein the instructions, when executed by the at least one processor individually or collectively, cause the electronic device to:
receive an UL data frame from the non-AP MLD, wherein the information indicates that the UL unpause mode is not supported;
transmit a block acknowledgment frame indicating successful reception of the UL data frame; and
drop the received UL data frame based on the UL unpause mode not being supported.

19. The electronic device of claim 15, wherein the information indicating whether the UL unpause mode is supported is included in a neighbor report in a background traffic management (BTM) request frame.

20. The electronic device of claim 15, wherein the information indicating whether the UL unpause mode is supported is included in a management frame.
